(19) United States
(12) Patent Application Publication
(10) Pub. No.: US 2015/0073845 A1
(43) Pub. Date: Mar. 12, 2015

(54) WIRELESS COVERAGE INFRASTRUCTURE DESIGN

(71) Applicant: Consistel Pte Ltd., Singapore (SG)

(72) Inventor: Masoud Bassiri, Singapore (SG)

(21) Appl. No.: 14/394,244

(22) PCT Filed: Mar. 20, 2013
(86) PCT No.: PCT/SG2013/000111

§ 371 Date: Oct. 13, 2014

(30) Foreign Application Priority Data
Apr. 16, 2012 (SG) 201202777-7

(51) Int. Cl. G06Q 10/06; H04W 16/18

(52) U.S. Cl. CPC G06Q 10/0631; H04W 16/18
USPC 705/7.12

(57) ABSTRACT

A system and method for wireless communication network deployment. The system includes a computer having a processor and memory and a plurality of interfaces including: a building data interface, a network design interface, and a project management interface. The building data interface is configured to receive and process, by the computer, building data, network data, network KPI's and financial data and generate, by the computer, a model of obstacles and their conglomeration within the environment of interest (digitized building model). The network design interface is configured to generate, a network design based upon the digitized building model and the network KPI's and to analyse, by the computer, interaction between the network model and the model of the obstacles and their conglomeration within the environment of interest. The project management interface, configured to schedule, by the computer, the projects, and automatically generates tasks and plans resources based upon the network design. A digitized building model is generated by the invention through data inputs into the system and stored in the data store. The digitized building model is created by the network design interface. The controller provides an interface between the interfaces and the data store. The data used between the interfaces is accessible in a standardized manner.

### FIELD OF THE INVENTION

The present invention generally relates to wireless coverage infrastructure design. In particular, although not exclusively, the invention relates to design and deployment of a wireless communication network.

### BACKGROUND OF INVENTION

The design and deployment of a wireless infrastructure is a largely manual process where a series of tasks, such as site preparation, site acquisition, site selection, network design, design approval, procurement, project management, documentation, etc., are performed in isolation. Transfer of information between tasks occurs manually.

The manual transfer of information between tasks prevents real time operation and communication between departments and other stakeholders. This hinders efficient collaboration, adversely affects operational continuity, causes inefficiencies and increases the possibility of erroneous data creeping into the system. The manual transfer of information requires various parties to re-enter data in different applications and formats and involves an inefficient review, revision and approval process.

Isolated standard applications software such as Microsoft Word for project documentation, Microsoft Excel for Link Budget calculations, Microsoft Powerpoint/Visio and AutoCAD for Network Drawings, Microsoft Project for scheduling and resource planning and various proprietary RF simulation tools such as iBWave and PlaNet have been used with each application introducing improvement in its own domain, but without addressing the inefficiencies of isolated task execution and manual transfer of information, as discussed above.

The manual transfer of information in the prior art relies heavily on hard copy submissions for information distribution, and is thus is not “Green”. On average one tree is killed per building per system per telco.

Additionally, the manual transfer of information may result in data loss. This may be due to human error when data is re-entered, or through a limited level of accuracy provided on the data sheets, for example.

As a result of the prior art methods and systems, most parties work in silo and do not have a holistic approach to the entire process. Data is not reused between departments efficiently, and eventually the same data is re-entered into several data bases. This silo-ing and under-management or non-management of data frequently results in an under-design or over-design of networks.

Additionally, the prior art does not re-use accumulated data in retrofit designs and upgrades to next generation wireless system. Data relating to earlier infrastructure may be lost or misplaced or with another contractor and cannot be reused later when an upgrade is performed.

There is therefore a need for improved process management.

### OBJECT OF THE INVENTION

It is an object of some embodiments of the present invention to provide wireless industry stakeholders with improvements and advantages over the above described prior art, and/or overcome and alleviate one or more of the above described disadvantages of the prior art, and/or provide a useful commercial choice.

### SUMMARY OF INVENTION

According to an embodiment, the present invention resides in a system for wireless communication network deployment: where the system is comprised of a control mechanism processing interactions between the system interfaces and/or between any of the system interfaces and the system data store. The system includes:
a computer having a processor and memory;

a shared and/or centralized data store for storing the data used by and between the system interfaces and controller;

a plurality of interfaces, configured to receive and export data, by the computer, including:

a building data interface (or a plurality of building data interfaces), configured to receive and export, by the computer, environment data, network data and financial data for the environment of interest; and

a network design interface (or a plurality of network design interfaces), configured to receive and export, by the computer, required network performance criteria and network model data, and

a project management interface (or a plurality of project management interfaces), configured to schedule, by the computer, the projects, and automatically generate tasks and plan resources based upon the network design, and track issues and change requests; and

a controller that manages the transfer of data between system interfaces and the data store; wherein data used between the system interfaces is accessible in a standardized manner; and processes the data transferred between the system interfaces and the data store, generating new data, including:
generating, by the computer, a model of obstacles and their conglomeration within the environment of interest; and
analysing and processing, by the computer, the network design data, building data and data generated from the building data, to generate, by the computer, a model of the network, and to analyse, by the computer, interaction between the network model and the model of the obstacles and their conglomeration within the environment of interest, from the environment data, and generates; and
scheduling, by the computer, the projects, and automatically generate tasks and plan resources based upon the network design, and track issues and change requests.

The system further includes a shared and/or central data store for storing the data used between the interfaces. Alternatively, the system further includes two or more independent databases for storing the data used between the interfaces, wherein at least part of the data is synchronized between the two or more independent data stores.

Preferably, the project management interface includes:
generating a bill of material for the particular project or building requirement, and
generating installation tasks matching the bill of material for the network design.

Preferably, the project management interface includes reception of cost information, and the building explorer module generates at least one of a capital expenditure and an operational expenditure for the building based upon the cost information and the network design.

Preferably, the system further includes an inventory management interface, including data relating to a warehouse inventory that may be used by the project management interface in material planning.

Preferably, the system further includes a vendor management interface, including vendor information, equipment quotations and payment terms that may be used by the project management module for project costing, pricing and cash flow planning.

Preferably, the system further includes a maintenance and upgrade interface, including a user interface and operable to run advanced searches on equipment in the RF Network design.

Preferably, the system further includes a component library, including component models and specifications for use in network design.

Preferably, the system further includes a dashboard interface, which extracts the status from the system data and generates a report based thereon.

According to another embodiment, the invention resides in a method for wireless communication network design and/or deployment, including:
Receiving, through a controller, building data;
generating, on a processor, a digitized building model from the building data;
generating, on a processor, a network design based upon the digitized building model; and
scheduling and planning, on a processor, the project and resources based upon the network design;
wherein the building data, the digitized building model and the network design data is accessible in a standardized manner.

Preferably, the method further includes storing, on a shared and/or central data store, the building data, the digitized building model, the network design data.

Alternatively, the method further includes:
storing, on two or more independent databases or system data stores, the building data, the digitized building model, the network design data; and
synchronizing and interacting, at least part of the data, between the two or more independent data stores or system data stores.

Preferably, the method further includes:
receiving, through a controller, cost information;
generating, on a processor, at least one of a capital expenditure and an operational expenditure for the building and the revenue from the network, based upon the cost information and wireless network usage profiles.

Preferably, the method further includes:
receiving, through a controller, data relating to a warehouse inventory; and
planning material based upon the warehouse inventory data.

Preferably, the method further includes:
receiving, through a controller, data relating to equipment quotations and payment terms; and
generating project costing, pricing and cash flow based upon the data relating to equipment quotations and payment terms.

Preferably, the generation of the network design includes a link budget calculation based upon component models and specifications.

Preferably, the method further includes the generation of a report based upon data created by one or more modules where the format and content of the report is determined through a controller.

Preferably, the method further includes:
modifying data in the system in a first interface;
reviewing the modified data from at least one other interface; and
using the modified data from at least one other interface.

Preferably, the method further includes:
generating installation tasks based upon the network design.

According to yet another embodiment, the invention resides in a method for wireless communication network design and/or deployment, including:
Receiving, through a controller, network KPI's (Key Performance Indicators);
generating, on a processor, a digitized building model from building data;
generating, on a processor, a network design based upon the network KPI's and the digitized building model; and
scheduling and planning, on a processor, the project and resources based upon the network design;
wherein the network KPI's and the network design data is accessible in a standardized manner.

Preferably, the method further includes storing, on a shared and/or central data store, the building data, the digitized building model, the network design data and the network KPI's.

Alternatively, the method further includes:
storing, on two or more independent databases or system data stores, the building data, the virtual building data, the network design data and the network KPI's; and
synchronizing and interacting, at least part of the data, between the two or more independent data stores or system data stores.

Preferably, the method further includes:
receiving, through a controller, cost information;
generating, on a processor, at least one of a capital expenditure and an operational expenditure for the building and the revenue from the network, based upon the cost information and wireless network usage profiles.

Preferably, the method further includes:
receiving, through a controller, data relating to a warehouse inventory; and
planning material based upon the warehouse inventory data.

Preferably, the method further includes:
receiving, through a controller, data relating to equipment quotations and payment terms; and
generating project costing, pricing and cash flow based upon the data relating to equipment quotations and payment terms.

Preferably, the generation of the network design includes a link budget calculation based upon component models and specifications.

Preferably, the method further includes the generation of a report based upon data created by one or more modules where the format and the content of the report is determined through a controller.

Preferably, the method further includes:
modifying data in the system in a first interface;
reviewing the modified data from at least one other interface; and
using the modified data from at least one other interface.

Preferably, the method further includes:
generating installation tasks based upon the network design.

The invented process management solution makes use of a data storage system software solution allowing integration of all facets of the business including internal and external communication.

According to an embodiment, network design, project planning and project implementation is implemented in a loop. The invention enables collaboration by ensuring all parties share the same information. This prevents delays and confusion due to poor version control.

The present invention allows for the data to be entered only once and used whenever required. The invention enables all parties to be involved in a dynamic review process where changes can be done immediately, and be reviewed and approved by all parties. Data entered in one module may be used to create another, more complex set of data. The new set of data is either used by other modules along the process or is fed back to the previous module(s) for automatic comparison and monitoring.

Inclusion of technical and commercial KPIs together with monitoring and comparison steps enable creation of wireless networks in a form that is neither over-designed nor under-designed. The ability to create an optimal design (based on set KPIs) significantly reduces material and resources employed.

Throughout the process the data accumulates and can be used to support other uses. The data is updated and exchanged bi-directionally between different interfaces.

The system enables common infrastructure sharing and retrofitting of old systems.

According to certain embodiments, integration of the inventory and material management functionality is present. This feature helps to reduce fraud and theft.

The present invention may be based on relational database architecture to enable real-time sharing of data.

Advantages of the present invention, according to certain embodiments, include:
Enhanced operational efficiencies through a shared and/or centralized data store;
Standardized processing;
Ability to achieve optimal performance based on set KPIs;
Integration of accounting practices and logistic functions into the automated process;
Integration of Inventory Management into the automated process;
Creating a single repository of all data related to buildings and projects;
Integration of Asset Management into the automated process;
Ability to store and recall information when it is required in a real-time environment;
Efficient inter and intra company communication;
Ability to design and implement the correct of infrastructure as both technical and management concerns are considered at the same time;
Communication between different parties is optimized as data is available to everyone in real time; and
Ability to reduce cost; reduce project implementation time; reduce waste (through reuse of material) and paper usage (green process).

### BRIEF DESCRIPTION OF THE FIGURES

To assist in understanding the invention and to enable a person skilled in the art to put the invention into practical effect, preferred embodiments of the invention are described below by way of example only with reference to the accompanying drawings, in which:

FIG. 1 illustrates a system for wireless communication network deployment in a building according to an embodiment of the present invention;

FIG. 2 illustrates a wireless coverage infrastructure deployment process, according to an embodiment of the present invention;

FIG. 3a illustrates elements involved in the prior art process using scattered applications and FIG. 3b illustrates how the present invention which uses a data store to interact and automate the process;

FIG. 4 illustrates four modes of operations to allow multiple users to access a single shared and/or centralized data store; and

FIG. 5 illustrates a mode of operation using multiple shared and/or centralized data stores of the present invention.

Those skilled in the art will appreciate that minor deviations from the layout of components as illustrated in the drawings will not detract from the proper functioning of the disclosed embodiments of the present invention.

### DETAILED DESCRIPTION OF EMBODIMENTS OF THE INVENTION

Embodiments of the present invention comprise systems and methods for wireless communication network deployment in a building. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to an embodiment, the invention utilizes a shared and/or centralized data store and three core modules which share the same data which can be used automatically by the other modules. The core modules are Building Explorer, Network Design and Project Management. The invention process integrates several applications through a shared and/or centralized data store and thereby allowing a real time flow of data. This enables enhanced logistics, inventory management, accounting and asset tracking.

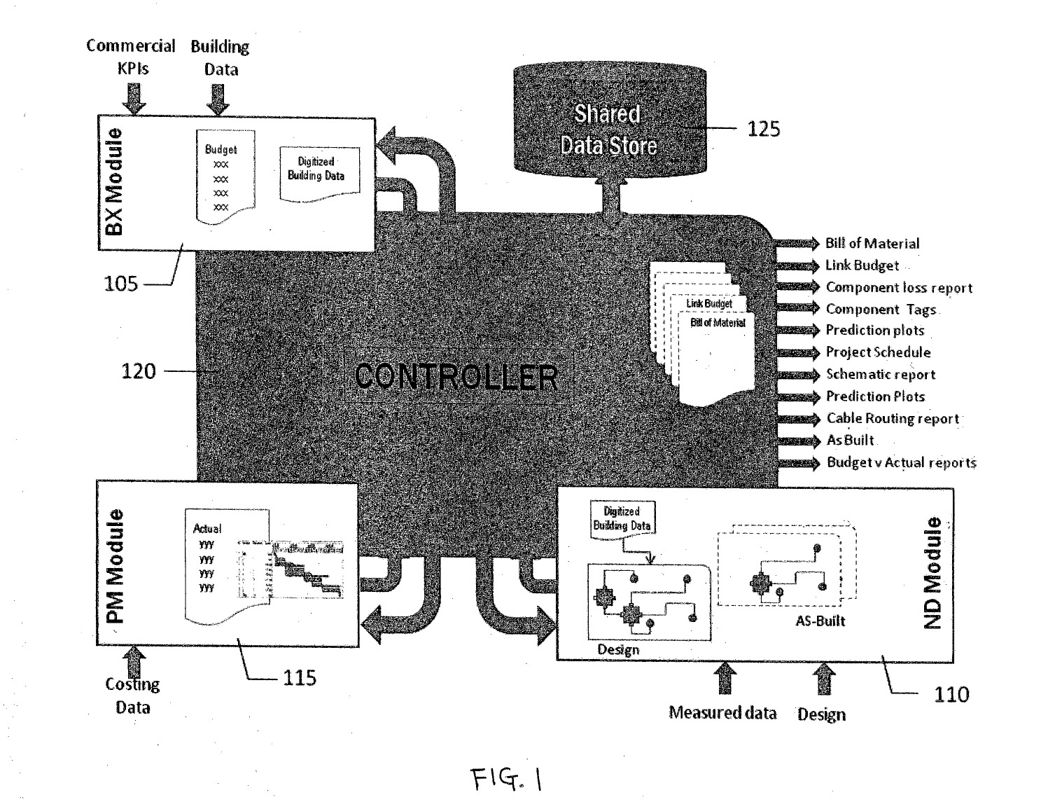

FIG. 1 illustrates a system 100 for wireless communication network deployment according to an embodiment of the present invention.

The system 100 includes a building explorer interface 105, a network design interface 110, and a project management interface 115. The data used between the interfaces is accessible in a standardized manner through a controller 120 which interacts with a shared and/or centralized data store 125. There is no direct contact between the interfaces. The controller interacts with all inputs from the interfaces and the data store, to decide which interface to retrieve information and which interface the information should go to. Validation is also determined by the controller. Thereafter, the controller produces outputs and reports. The format and the content of the report is determined through the controller.

The building data interface 105 is configured to receive and process building, network and financial data. The data received by the building data interface 105 may include commercial KPIs. The Building Data Interface 105 in the invention includes a repository of building information and network engineering and finance data. The capital expenditure (CAPEX) and operational expenditure (OPEX) can be estimated or generated in this interface.

A digitized building model is generated by the invention through data inputs into the system and stored in the data store 125. The digitized building model is created by the building data interface 105 and the digitized telecom network inside the building is created by the network design interface 110.

The network design interface 110 generates a network design based upon the digitized building model. The network design interface 110 may also include updated network data based upon the building and deployment of the network, or part thereof.

The network design interface 110 additionally includes interfaces for measured data model tuning and design KPI's. The measured data model tuning and design KPI's may additionally be used in the network design.

The project management interface 115 is configured to schedule the project and plan resources based upon the network design. The project management interface includes an interface to receive costing data, which is used to generate an actual cost which is reported to the building data interface 105.

The controller 120 mediates interactions and data flows between the interfaces and the data store(s).

The shared and/or centralized data store 125 stores data generated by and/or used by the interfaces 105-120, and this data is made accessible to all users. The data that may be extracted from the shared and/or centralized data store includes a bill of materials, a link budget, a component loss report, component tags, prediction plots, project schedule, schematic reports, prediction plots, a cable routing report, as-built network data, and budgeted vs actual cost reports, for example.

As will be readily understood by the skilled addressee, the system 100 is run on a computer (not shown) having a processor and memory.

The invention streamlines the entire process and gives all parties direct access to the same real time data. This reduces the need to enter and maintain the data across different parties leading to substantial increase in operational efficiencies. The invention minimizes the review and approval process as each party is involved in the dynamic process and can see the amendments and their effects real time.

The invention has given birth to a new concept of building/network digitization where the information related to the building and the existing wireless network is stored in a standardized format that can be readily used to evaluate the performance of an installed network infrastructure against usage by a higher generation wireless technology (higher generation than it was originally designed for). The feature allows optimal reuse of the existing infrastructure when upgrading to higher generations of wireless technologies.

The system 100 may include an inventory management interface (not shown). The inventory management interface contains warehouse inventory to be used for material planning in the project management interface. The inventory management module may include automatic generation of asset tags for one or more items in the inventory.

The system 100 may include a vendor management interface (not shown). The vendor management interface contains vendor information, equipment quotations and payment terms to be used in the project management for project costing, pricing and cash flow planning. The vendor management interface may include preferred vendors, or any other suitable categorization of vendors. Equipment quotations may include minimum and maximum quantities, quotation validity, or any other suitable information.

The system 100 may include a maintenance and upgrade interface (not shown). The maintenance and upgrade interface may be used to access information about an existing network which can be used to maintain the network, or as input when upgrading the network. The maintenance and upgrade interface includes an interface for the user to extract network design information and run advanced searches on equipment in the Network design and Inventory Management.

The system 100 may include a component library (not shown). The component library may be used to store component models and specifications used in the network design for link budget calculation. The component library enables data to be entered a single time relating to a specific component that is commonly used in a network.

The system 100 may include a dashboard (not shown). The dashboard acts as an interface to the data, and enables extraction of the status from the Building Data Interface and Project Management Interface. The dashboard may include automatic generation of reports, and advantageously includes an interactive user interface for presentation of data.

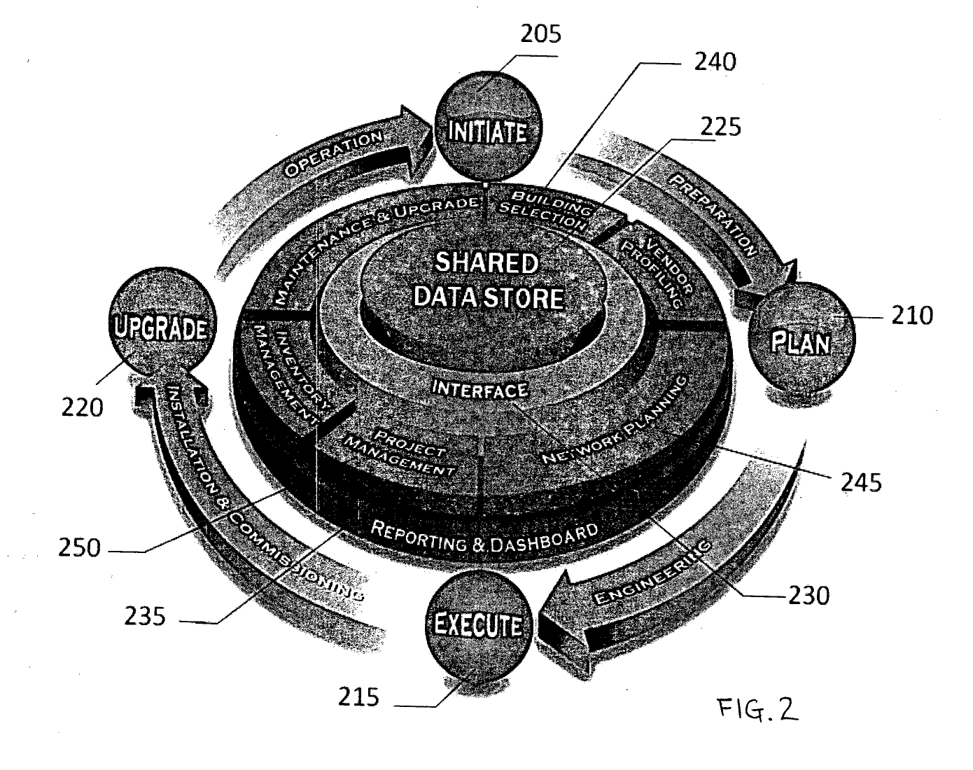

FIG. 2 illustrates a wireless coverage infrastructure deployment process 200 at the outer ring consisting of stages 205, 210, 215 and 220, and the invention is depicted within such a process at the inner rings, according to an embodiment of the present invention.

Data is collected and uploaded, and buildings are analyzed and prioritized at initiate stage 205. Data collection may be performed by querying another data store, or through a user interface, for example. Initiate stage 205 is advantageously initiated before acquiring a site.

Thereafter, in the plan stage 210, the wireless network is designed and the network version is approved. The network design includes generation of a network design based upon the data collected at initial stage 205.

At the execute stage 215, project cost and pricing are managed, the project is scheduled and resources are planned before the network design is optimized and updated.

At the upgrade stage 220, the components are identified to be upgraded or maintained. The network design is retrofitted thereafter.

The Building Data Interface 105 accesses a repository of building information and financial data contained in the data store which is used in the site/project/building prioritization and selection process 240. The Network Design Interface 245 in the invention relates to design of the network. Building data is extracted and used to generate a digitized building model in the system. The digitized building model includes models of floors that are created automatically. The digitized building model may be used to create the network design and generate the Bill of Material. The network design may be performed on a floor level and include a floor level Bill of Material.

The Project Management Interface is used in the project management stage for project schedule and resource planning. The floor level Bill of Material is used to automatically generate an installation task. A network level Bill of Material is automatically generated from the floor level Bill of Materials.

The user then enters the financial or cost information relating to the materials. Alternatively, the cost information may be pre-stored in a vendor management interface through equipment quotations, for example.

In the Building Data Interface, the updated financial information from the Project Management Interface is extracted and used to generate the actual CAPEX for the site.

The enterprise database 225 stores the data which can be used by all interfaces. The data is stored in a standardized manner such that it is readily accessible by all interfaces.

The interface layer 230 represents where the interfaces and the database meet. Data is continuously built up by each interface and stored in the enterprise database 225. The enterprise database 225 has a relational database architecture that makes common data available to all interfaces. In other words, the data contributed by each interface is used by other interfaces.

The reporting and dashboard interface 235 represents the interface to the outside world in the shape of reports and access to the centralized data. The dashboard may include automatic report generation, and an interactive display, for example.

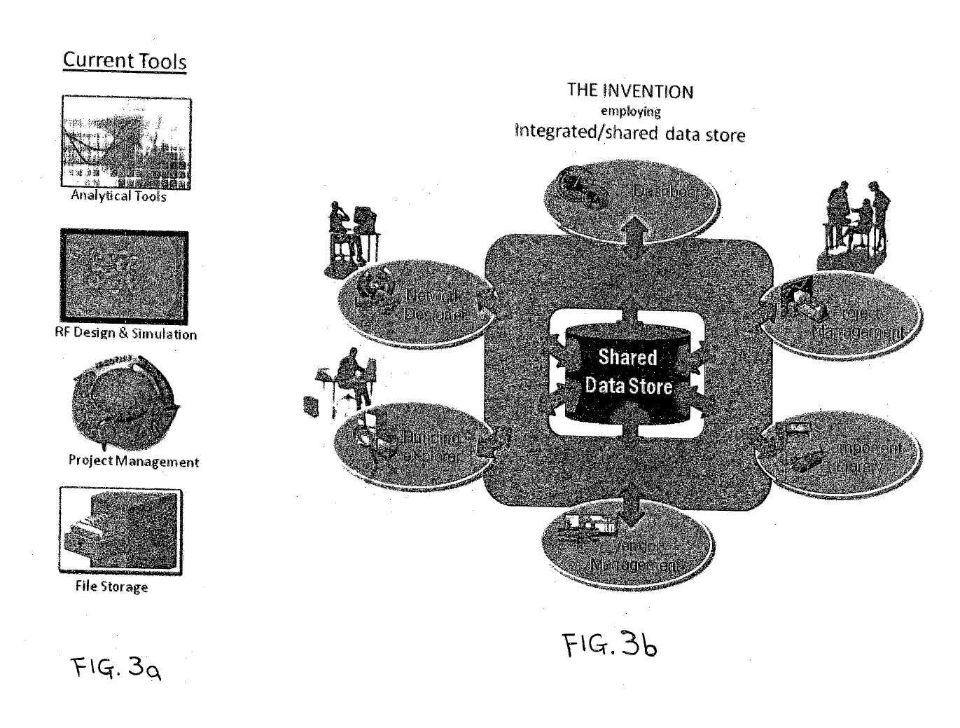

FIG. 3a illustrates elements of the prior art process which uses scattered applications and FIG. 3b illustrates how the present invention uses a data store to interact and automate the process.

In the current manual process as shown in FIG. 3a, various processes are handled with largely independent applications with delayed data transfer between applications. In contrast, the present invention, as illustrated in FIG. 3b, integrates several functions through a shared and/or centralized data store and thereby allowing a real time flow of data through a controller. For example, a change such as replacement of a component with another made in the wireless network design process is stored and the new data is instantly made available to the project management & procurement processes.

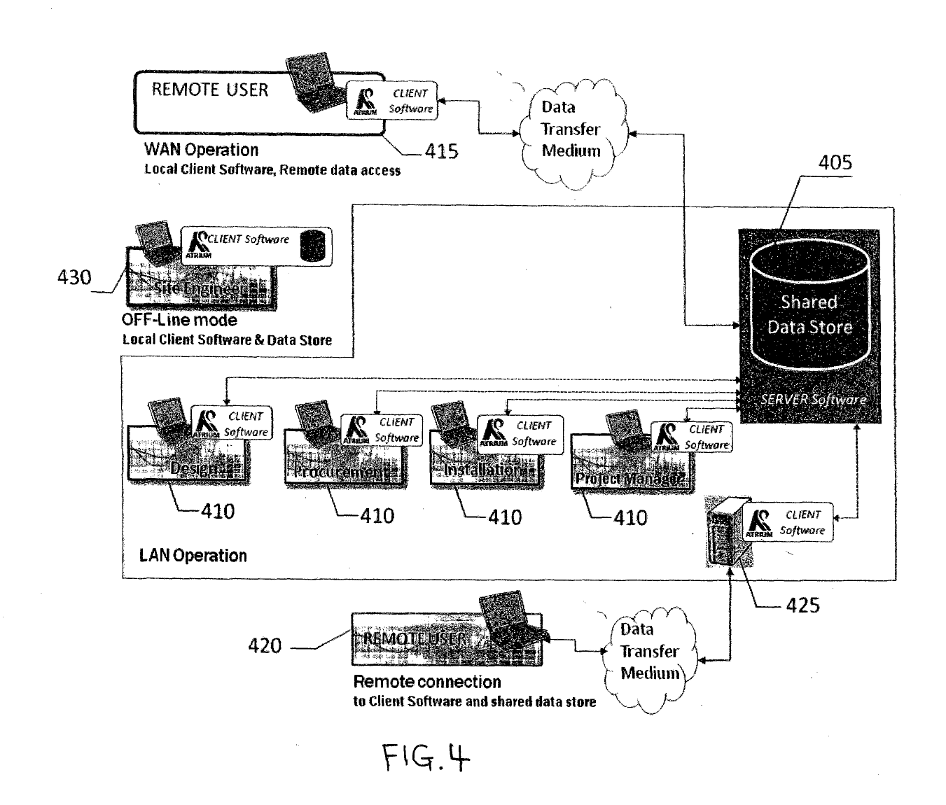

FIG. 4 illustrates four modes of operations to allow multiple users to access a single centralized database 405.

Access to the database via LAN is illustrated through users 410. The users may have different roles such as project manager, installation, procurement or design.

Access to the database via WAN is illustrated through the remote user 415. The remote user connects to the centralized database via the Internet, and has client software locally installed.

An alternative access mode to the data store via remote connection is illustrated via remote user (subcontractor for example) 420. The user 420 connects, via the Internet, to a remote connection server 425, which includes client software.

Off-Line access to the database via client software with a copy of the database is illustrated by off-line user (site engineer for example) 430.

The present invention allows accessibility to a centralized data by all parties involved in the workflow for the project. This includes parties who enter the building data, perform the network design, project planning and approval, sub-contractors etc. All parties access and write data in the same database.

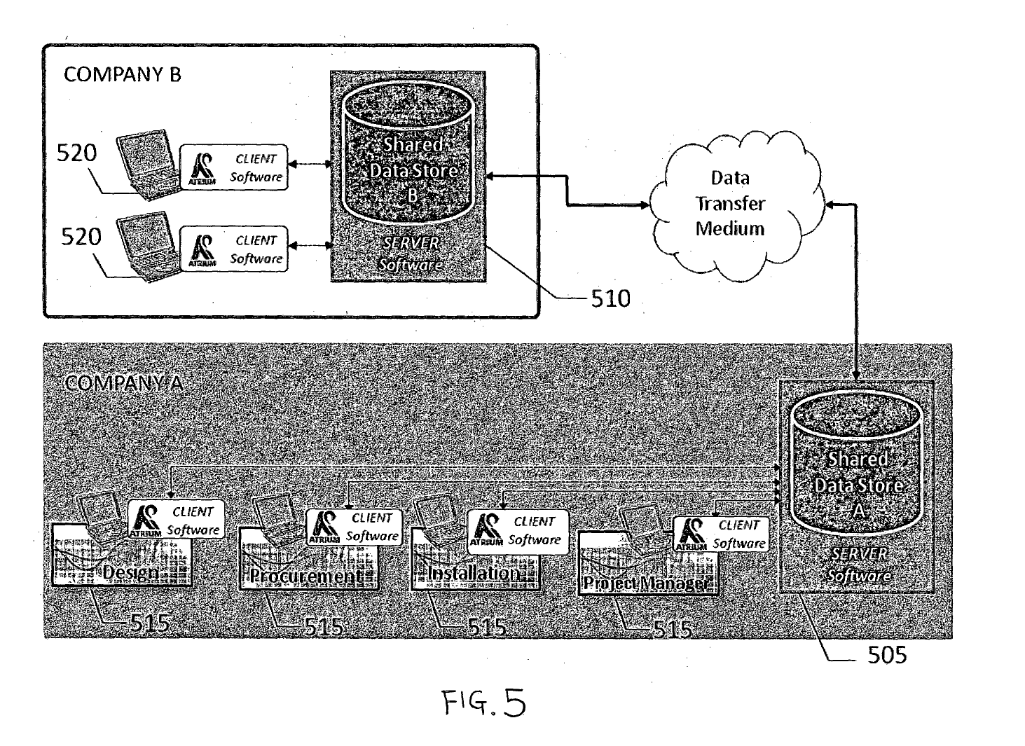

FIG. 5 illustrates a mode of operation using multiple shared and/or centralized data stores of the present invention.

The system 500 includes a first shared and/or centralized data store 505 associated with a first company, and a second shared and/or centralized data store 510 associated with a second company.

The first shared and/or centralized data store 505 and the second shared and/or centralized data store 510 are connected via the internet and are synchronized. Collaboration takes place via sharing information through real-time exchange of data between two shared and/or centralized data stores 505, 510.

Users 515 located at the first company may access data from the first shared and/or centralized data store 505, while users 520 located at the second company access data from the second shared and/or centralized data store 510. If the shared and/or centralized data stores 505, 510 are synchronized fully, the data accessible by users 515, 520 is the same.

In summary, advantages of some embodiments of the present invention include enhanced operational efficiencies through a shared and/or centralized data stores, standardized processing, efficient inter and intra company communication and collaboration and an ability to design and implement the correct of infrastructure as both technical and management concerns are considered at the same time. This reduces cost, project implementation time, and waste.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A system for wireless communication network deployment where the system is comprised of a control mechanism processing interactions between the system interfaces and/or between any of the system interfaces and the system data store. The system includes:
(a) a computer having a processor and memory;
(b) a shared and/or centralized data store for storing the received and generated data used by and between the system interfaces and controller;
(c) a plurality of interfaces, configured to receive, generate and export data, by the computer, including:
(i) a building data interface (or a plurality of building data interfaces), configured to receive, generate and export, by the computer, environment data, network data and financial data for the environment of interest; and
(ii) a network design interface (or a plurality of network design interfaces), configured to receive, generate and export, by the computer, required network performance criteria and network model data, and
(iii) a project management interface (or a plurality of project management interfaces), configured to schedule, by the computer, the projects, and automatically generate tasks and plan resources based upon the network design, and track issues and change requests; and
(iv) a vendor management interface (or a plurality of vendor management interfaces), configured to receive, generate and export, by the computer, vendor, equipment and payment data;
(v) a maintenance and upgrade interface (or a plurality of maintenance and upgrade interfaces), configured to receive, generate and export, by the computer, installed network data;
(vi) a dashboard interface (or a plurality of dashboard interfaces), configured to receive, aggregate and export, by the computer, data from the data store;
(d) a controller that manages the transfer of data between system interfaces and the data store; wherein data used between the system interfaces is accessible in a standardized manner; and processes the data transferred between the system interfaces and the data store, generating new data, including:
(i) generating, by the computer, a model of obstacles and their conglomeration within the environment of interest;
(ii) analysing and processing, by the computer, the network design data, building data and data generated from the building data, to automatically generate, by the computer, a model of the network, and to analyse, by the computer, interaction between the network model and the model of the obstacles and their conglomeration within the environment of interest, from the environment data, and generates;
(iii) scheduling, by the computer, the projects, and automatically generate tasks and plan resources based upon the network design, and track issues and change requests; and
(e) a controller that manages the synchronisation of all or part of the data between two or more independent data stores.

2. A system according to claim 1, wherein the project management interface includes:
automatically generating a bill of material for the particular project or building requirement according to data received or generated by other interfaces, and
automatically generating installation tasks matching the bill of material for the network design according to data received or generated by other interfaces,
automatically calculating the capital expenditure based on cost information for the network design,
automatically updating project costing, pricing and cash flow planning according to data received or generated by other interfaces.

3. A method for wireless communication network deployment employed by the system in claim 1, including:
receiving, through a controller, building data and network KPIs;
generating, on a processor, a digitized building model from the building data;
generating, on a processor, a network design based upon the digitized building model;
generating, on a processor, a link budget based upon the specifications of the component models within the network design; and
scheduling and planning, on a processor, the project and resources based upon the network design;
wherein the building data, the digitized building model, the network design data and project schedule and resource data is accessible from a shared and/or centralized data store in a standardized manner.

4. A method according to claim 3, further including:
receiving, through a controller, cost information;
generating, on a processor, at least one of a capital expenditure and an operational expenditure for the building and the revenue from the network, based upon the cost information and wireless network usage profiles.

5. A method according to claim 3, further including:
receiving, through a controller, data relating to equipment quotations and payment terms; and
generating project costing, pricing and cash flow based upon the data relating to equipment quotations and payment terms.

6. A method according to claim 3, further including:
importing or modifying data in the system in a first interface;
receiving the modified data from at least one other interface; and
receiving, generating and exporting the modified data from at least one other interface.
